(19) United States
(12) Patent Application Publication
(10) Pub. No.: US 2016/0102819 A1
(43) Pub. Date: Apr. 14, 2016

(54) LIGHT SOURCE DEVICE AND VEHICLE LAMP

(71) Applicant: HITACHI MAXELL, LTD., Ibaraki-shi, Osaka (JP)

(72) Inventors: Tomonari MISAWA, Tokyo (JP); Kousaku MORITA, Tokyo (JP)

(73) Assignee: HITACHI MAXELL, LTD., Ibaraki-shi, Osaka (JP)

(21) Appl. No.: 14/785,929

(22) PCT Filed: Apr. 24, 2013
(86) PCT No.: PCT/JP2013/062113

§ 371 Date: Oct. 21, 2015

(51) Int. Cl. F21K 99/00; F21S 8/10; F21V 9/16

(52) U.S. Cl. CPC F21K 9/56; F21V 9/16; F21S 48/1225

(57) ABSTRACT

A light source device which includes a light source which emits excitation light and a fluorescent layer which emits fluorescent light by the excitation light from the light source, mixes the fluorescent light emitted from the phosphor layer with the excitation light diffused and reflected in the phosphor layer, and emits illumination light. The phosphor layer includes a plurality of phosphor particles which emit the fluorescent light by the excitation light and a plurality of diffusion reflection particles which diffuse and reflect the excitation light. The plurality of phosphor particles and the plurality of diffusion reflection particles are dispersed in the phosphor layer. It is possible to reduce a regular reflection amount and adjust a color mixing ratio between the fluorescent light emitted from the phosphor layer and the excitation light diffused and reflected therein according to a mixed amount of the diffusion reflection particles 7.

### TECHNICAL FIELD

The present invention relates to a light source device using a phosphor and an excitation light source. Particularly, the present invention relates to a vehicle lamp using a laser light emitting element as the excitation light source.

### BACKGROUND ART

Recently, in a vehicle lamp such as a vehicle headlight, a product using a light emitting diode (LED) or a laser diode (LD) has been proposed in order to reduce energy consumption of a light source, and some of the products have been put into practical use. Particularly, a LD light source has a high phototransformation efficiency and a small light emitting area, and therefore, is advantageous for downsizing a lamp. A vehicle lamp using a LD light source irradiates a phosphor with excitation light (for example, blue laser light) from a LD element, mixes the excitation light with light (for example, yellow light) emitted from the exited phosphor, and emits visible light (for example, white light).

For example, JP 2012-104267 A (PTL 1) describes a light source device including a solid light source and a phosphor layer. The solid light source emits light with a prescribed wavelength out of a wavelength region from ultraviolet light to visible light. The phosphor layer includes at least one kind of phosphor which is excited by excitation light from the solid light source, and emits fluorescent light with a longer wavelength than a light emitting wavelength of the solid light source. In this light source device, the solid light source and the phosphor layer are located spatially in separation, and the fluorescent light is at least extracted by a reflection method from a surface of the phosphor layer on a side on which the excitation light is incident. On the surface of the phosphor layer on the side on which the excitation light is incident, a light diffusing unit is provided for diffusion of the excitation light from the solid light source.

### CITATION LIST

### Patent Literature

PTL 1: JP 2012-104267 A

### SUMMARY OF INVENTION

### Technical Problem

When a phosphor is irradiated with excitation light from a LD element, the excitation light is mixed with light emitted by excitation of the phosphor, and visible light is emitted, the excitation light reflected by the phosphor is divided into a diffusion reflection component having no angular dependency and a regular reflection component having a strong directivity in a direction of a reflection angle. Among these components, the diffusion reflection component having no angular dependency is mixed with light emitted from the phosphor, having no angular dependency similarly, and can be used as illumination light. On the other hand, the regular reflection component having a strong directivity may cause color unevenness of emitted light, or may damage eyes of a human when the regular reflection component is emitted outside while having the strong directivity. Therefore, the regular reflection component cannot be used, and is a main cause of energy loss.

Meanwhile, in the light source device described in PTL 1, the regular reflection component is reduced by providing an uneven structure having a light diffusion function on a surface of the phosphor layer on a side on which the excitation light is incident. The uneven structure is formed by surface processing of a phosphor layer or arrangement of particulate matters on a surface of a phosphor layer.

However, when unevenness is formed by the surface processing of a phosphor layer, phosphor particles may be damaged during processing to lower a luminous efficiency of a phosphor. When a phosphor having a high absorption efficiency of excitation light is used, a large amount of excitation light may be absorbed by the phosphor, an amount of excitation light diffused and reflected may be insufficient, and it may be difficult to realize chromaticity necessary for a light source device.

When uneven is formed by arrangement of particulate matters on a surface of a phosphor layer, in a case where the particulate matters are formed of the same material as the phosphor layer, a similar problem to the above surface processing arises. When the particulate matters are formed of a material different from a phosphor layer, fluorescent light emitted from the phosphor layer may be dispersed backward by the particulate matters on the surface, may not be extracted outside, and may cause energy loss.

The present invention provides a light source device and a vehicle lamp in which energy loss is reduced and emitted light can be designed so as to have desired chromaticity.

### Solution to Problem

In order to solve the above problem, in the present invention, a light source device includes a light source which emits excitation light and a fluorescent layer which emits fluorescent light by the excitation light from the light source, mixes the fluorescent light emitted from the phosphor layer with the excitation light diffused and reflected in the phosphor layer, and emits illumination light. In the light source device, the phosphor layer includes a plurality of phosphor particles which emit fluorescent light by the excitation light and a plurality of diffusion reflection particles which diffuse and reflect the excitation light. The phosphor layer diffuses the plurality of phosphor particles and the plurality of diffusion reflection particles.

### Advantageous Effects of Invention

According to the present invention, it is possible to provide a light source device and a vehicle lamp in which energy loss is reduced and emitted light can be designed so as to have desired chromaticity.

For example, the diffusion reflection particles included in the phosphor layer diffuse and reflect excitation light, and can reduce a regular reflection amount. Therefore, energy loss can be reduced. It is possible to adjust a color mixing ratio between the fluorescent light emitted from the phosphor layer and the excitation light diffused and reflected according to a mixed amount of the diffusion reflection particles. Therefore, it is possible to design the emitted light so as to have desired chromaticity.

Problems, structures, and effects other than the above will be clarified by the following description of embodiments.

### BRIEF DESCRIPTION OF DRAWINGS

FIG. 1 is a perspective view illustrating a structure of a vehicle lamp in Example 1.

FIG. 2 is a cross sectional view of a main part of a phosphor layer in Example 1.

FIG. 3 is a cross sectional view of a main part of a phosphor layer in Example 2.

FIG. 4 is a cross sectional view of a main part of a phosphor layer in Example 3.

FIG. 5 is a cross sectional view of a main part of a phosphor layer in Example 4.

FIG. 6 is a cross sectional view of a main part of a phosphor layer in Example 5.

### DESCRIPTION OF EMBODIMENTS

In the following embodiments, if necessary for convenience, an embodiment will be described by dividing the embodiment into a plurality of sections or embodiments. However, unless specifically indicated, these sections or embodiments have a relationship to each other, and one is a modification example, details, or supplementary explanation of a part or the whole of the other.

In the following embodiments, when the number of an element or the like (including the number of articles, numerical value, quantity, range, and the like) is referred to, for example, unless specifically indicated or clearly limited to a specific number in principle, the number is not limited to the specific number, and may be the specific number or more and the specific number or less.

In the following embodiments, needless to say, for example, unless specifically indicated or clearly considered to be indispensable in principle, a component (including a component step or the like) is not necessarily indispensable.

Needless to say, when “formed from A”, “formed of A”, “having A”, or “including A” is described, for example, unless it is specifically indicated that only the element is included, elements other than the element are not excluded. Similarly, in the following embodiments, when a shape, a positional relation, or the like of a component or the like is referred to, for example, unless specifically indicated or clearly considered to be untrue in principle, for example, a shape substantially approximate or similar to the shape or the like is also included. The above numerical value and range are similar to this.

In all the drawings for describing the following embodiments, basically, the same reference sign is given to components having the same function, and repeated description thereof will be omitted. Hereinafter, the embodiments will be described in detail based on the drawings.

For the description, a vehicle lamp will be exemplified. However, the embodiment is not limited to the vehicle lamp, and is only required to be a light source device which irradiates a phosphor with excitation light from an excitation light source, and mixes the excitation light with light emitted by excitation of the phosphor to emit visible light.

### Example 1

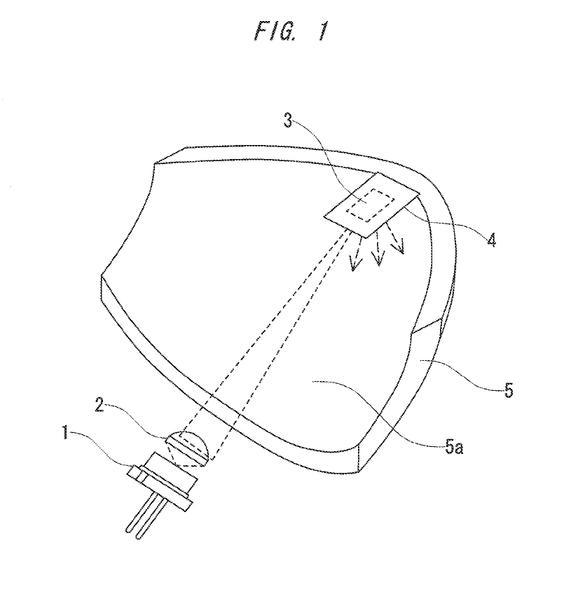

FIG. 1 is a perspective view illustrating a structure of a vehicle lamp in Example 1.

The vehicle lamp in Example 1 is a projector-type lamp, and includes a semiconductor light emitting element 1, a condensing lens 2, a phosphor layer 3, a metal plate 4, and a reflector 5. A laser diode (LD) is used for the semiconductor light emitting element 1 as a light source, and emits blue laser light as excitation light of the phosphor layer 3. The condensing lens 2 is disposed on an emitting side of the semiconductor light emitting element 1, and condenses the excitation light (blue laser light) emitted from the semiconductor light emitting element 1 on a surface of the phosphor layer 3 disposed above.

The reflector 5 is formed into a curved plate shape opening in an upward obliquely forward direction, and is disposed so as to face a lower part of the phosphor layer 3. The top surface of the reflector 5 is a reflection surface 5a which reflects fluorescent light emitted from the phosphor layer 3 and excitation light diffused and reflected forward. The reflection surface 5a is formed into a free curved surface shape, for example, a shape based on a parabolic surface, in order to obtain desired light distribution. The reflection surface 5a is disposed so as to face the phosphor layer 3 from the rear of the phosphor layer 3 to the lower part thereof. The reflection surface 5a irradiates the front of a vehicle with fluorescent light emitted from the phosphor layer 3 and excitation light diffused and reflected.

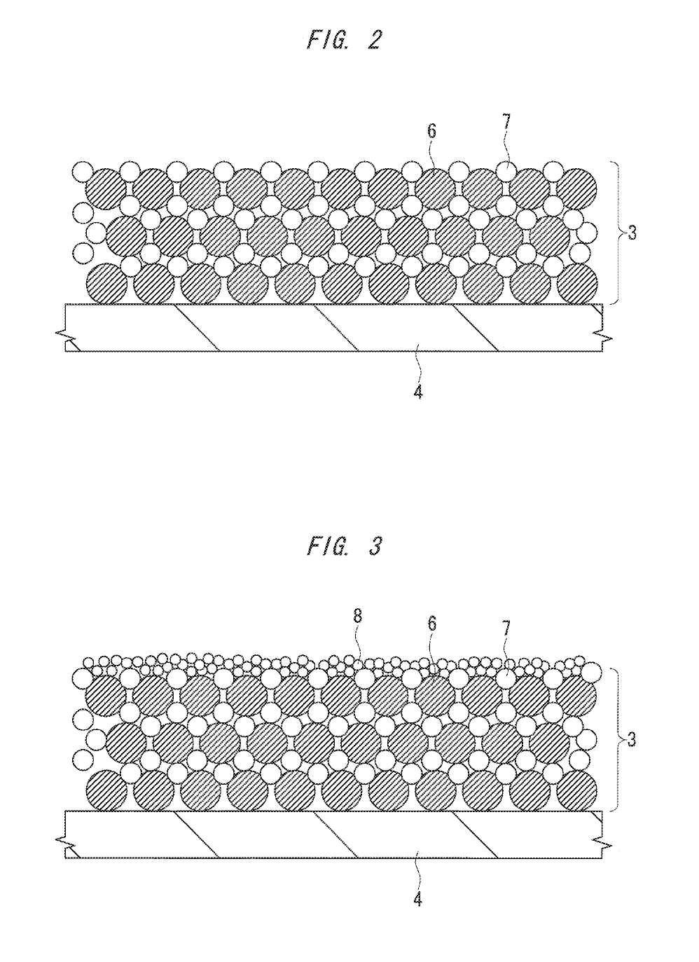

FIG. 2 is a cross sectional view of a main part of a phosphor layer in Example 1.

The phosphor layer 3 in Example 1 includes a plurality of phosphor particles 6 and a plurality of diffusion reflection particles 7. The phosphor particles 6 are made of a fluorescent material which emits fluorescent light by excitation of blue light. Examples thereof include Y₃Al₅O₁₂:Ce, Y₃(Al,Ga)₅O₁₂:Ce, (Y,Gd)₃Al₅O₁₂:Ce, (Y,Lu)₃Al₅O₁₂:Ce, (Ba,Sr)₂SiO₄:Eu, Ca₃Sc₂Si₃O₁₂:Ce, (Ca,Sr)₂Si₅N₈:Eu, (Ca,Sr)AlSiN₃: Eu, Cax(Si,Al)₁₂(O,N)₁₆:Eu, (Si,Al)₆(O,N)₈:Eu, (Ba,Sr,Ca)Si₂O₂N₂:Eu, Ca₈MgSi₄O₁₆C₁₂:Eu, SrAl₂O₄:Eu, Sr₄Al₁₄O₂₅:Eu, (Ca,Sr)S:Eu, ZnS:Cu,Al, CaGa₂S₄:Eu, and SrGa₂S₄:Eu.

The diffusion reflection particles 7 are made of a material which diffuses and reflects excitation light and slightly absorbs the excitation light and fluorescent light emitted from the phosphor particles 6. It is possible to use a material having translucency with respect to excitation light and fluorescent light, such as Al₂O₃, MgO, SiO₂, TiO₂, BaSO₄, SrTiO₄, Y₂O₃, La₂O₃, Y₃Al₅O₁₂, diamond, or various clear glass.

A part of the excitation light incident on the diffusion reflection particles 7 is reflected due to a refractive index difference between the surface of the diffusion reflection particles 7 and the air. By the particulate shape, a reflection surface with respect to an incident direction of the excitation light is random for each particle, and therefore, a reflection direction is also random. Uniform diffusion reflection can be realized. Apart of the excitation light and fluorescent light goes from the surface of the phosphor layer 3 toward the inside thereof. However, the excitation light and fluorescent light are reflected to the surface of the phosphor layer 3 by the diffusion reflection particles 7 inside the phosphor layer 3. Therefore, the excitation light and fluorescent light can be extracted efficiently to reduce energy loss. A ratio of the excitation light diffused and reflected with respect to the fluorescent light can be adjusted by a mixed amount of the diffusion reflection particles 7.

In Example 1, a material having translucency with respect to excitation light and fluorescent light was used as the diffusion reflection particles 7. However, a material having reflectivity with respect to excitation light and fluorescent light, such as Al, Ag, or Pt, can be also used.

An example of a method for forming the phosphor layer 3 will be described. The phosphor particles 6 and the diffusion reflection particles 7 are mixed at a predetermined ratio, and compacted with a press machine to obtain a pellet. Subsequently, the pellet is heated in a heating furnace to be sintered. The sintered pellet is fixed to the metal plate 4 using an adhesive, a double sided tape, metal solder bonding, or the like.

In this way, the vehicle lamp in Example 1 can reduce a regular reflection amount of excitation light and reduce energy loss. It is possible to adjust a color mixing ratio between the fluorescent light emitted from the phosphor layer 3 and the excitation light diffused and reflected according to a mixed amount of the diffusion reflection particles 7. Therefore, it is possible to design the emitted light so as to have desired chromaticity.

### Example 2

In Example 2, an example of a vehicle lamp will be described, which can deal with a high output in the vehicle lamp described in Example 1.

FIG. 3 is a cross sectional view of a main part of a phosphor layer in Example 2. A structure of the vehicle lamp in Example 2 is the same as that in Example 1, described above and illustrated in FIG. 1. Therefore, description thereof will be omitted.

The phosphor layer 3 in Example 1 includes a plurality of phosphor particles 6, a plurality of diffusion reflection particles 7, and a plurality of surface heat conductive materials 8. The phosphor particles 6 are made of a fluorescent material which emits fluorescent light by excitation of blue light. Examples thereof include Y₃Al₅O₁₂:Ce, Y₃(Al,Ga)₅O₁₂:Ce, (Y,Gd)₃Al₅O₁₂:Ce, (Y,Lu)₃Al₅O₁₂:Ce, (Ba,Sr)₂SiO₄:Eu, Ca₃Sc₂Si₃O₁₂:Ce, (Ca,Sr)₂Si₅N₈:Eu, (Ca,Sr)AlSiN₃:Eu, Cax(Si,Al)₁₂(O,N)₁₆:Eu, (Si,Al)₆(O,N)₈:Eu, (Ba,Sr,Ca) Si₂O₂N₂:Eu, Ca₈MgSi₄O₁₆C₁₂:Eu, SrAl₂O₄:Eu, Sr₄Al₁₄O₂₅:Eu, (Ca,Sr) S:Eu, ZnS:Cu,Al, CaGa₂S₄:Eu, and SrGa₂S₄:Eu.

The diffusion reflection particles 7 are made of a material which diffuses and reflects excitation light and slightly absorbs the excitation light and fluorescent light emitted from the phosphor particles 6. It is possible to use a material having translucency with respect to excitation light and fluorescent light, such as Al₂O₃, MgO, SiO₂, TiO₂, BaSO₄, SrTiO₄, Y₂O₃, La₂O₃, Y₃Al₅O₁₂, diamond, or various clear glass.

A part of the excitation light incident on the diffusion reflection particles 7 is reflected due to a refractive index difference between the surface of the diffusion reflection particles 7 and the air. By the particulate shape, a reflection surface with respect to an incident direction of the excitation light is random for each particle, and therefore, a reflection direction is also random. Uniform diffusion reflection can be realized. Apart of the excitation light and fluorescent light goes from the surface of the phosphor layer 3 toward the inside thereof. However, the excitation light and fluorescent light are reflected to the surface of the phosphor layer 3 by the diffusion reflection particles 7 inside the phosphor layer 3. Therefore, the excitation light and fluorescent light can be extracted efficiently to reduce energy loss. A ratio of the excitation light diffused and reflected with respect to the fluorescent light can be adjusted by a mixed amount of the diffusion reflection particles 7.

In Example 2, a material having translucency with respect to excitation light and fluorescent light was used as the diffusion reflection particles 7. However, a material having reflectivity with respect to excitation light and fluorescent light, such as Al, Ag, or Pt, can be also used.

The surface heat conductive material 8 is formed on a surface of the phosphor layer 3, particularly to cover a surface of the phosphor particles 6. The surface heat conductive material 8 has high thermal conductivity and translucency with respect to excitation light and fluorescent light emitted from the phosphor particles 6 Examples thereof include Al₂O₃, MgO, SiO₂, TiO₂, BaSO₄, SrTiO₄, Y₂O₃, La₂O₃, Y₃Al₅O₁₂, diamond, and various clear glass. The surface heat conductive material 8 may include the same material as the diffusion reflection particles 7. The surface heat conductive material 8 may have a particulate shape or a film shape.

A part of energy of excitation light absorbed in the phosphor particles 6 is radiated as fluorescent light. However, the remaining energy of excitation light mainly becomes heat, raises the temperature of the phosphor particles 6, and lowers a fluorescent light efficiency due to temperature quenching. Heat of the phosphor particles 6 is radiated to the air in contact with the surface of the phosphor particles 6 and adjacent particles. However, when thermal conductivity of the air is poor and a contact area between the adjacent particles is small, a radiation amount is small, energy of excitation light which can be input is limited, and an illumination output is limited. The surface heat conductive material 8 covers a surface on a side where excitation light emitted by the phosphor particles 6 has a higher density. The surface heat conductive material 8 has high thermal conductivity. Therefore, the surface heat conductive material 8 can disperse and radiate heat generated on the surface of the phosphor particles 6 and can suppress raise of the temperature of the phosphor particles 6.

An example of a method for forming the phosphor layer 3 will be described. The phosphor particles 6 and the diffusion reflection particles 7 are mixed at a predetermined ratio, and compacted with a press machine to obtain a pellet. Thereafter, the surface heat conductive material 8 is formed on a surface of the pellet by printing, coating, dipping, deposition, or the like. The pellet on the surface of which the surface heat conductive material 8 is formed is heated in a heating furnace to be sintered. The sintered pellet is fixed to the metal plate 4 using an adhesive, a double sided tape, metal solder bonding, or the like.

In Example 2, the surface heat conductive material 8 is formed only on the surface of the phosphor layer 3. However, the surface heat conductive material 8 may be dispersed inside the phosphor layer 3 as long as the surface of the phosphor particles 6 located on the surface of the phosphor layer 3 is covered with the surface heat conductive material 8.

### Example 3

In Example 3, an example of a vehicle lamp will be described, which can use a phosphor material or a diffusion reflection material having low moisture resistance in the vehicle lamp described in Example 1.

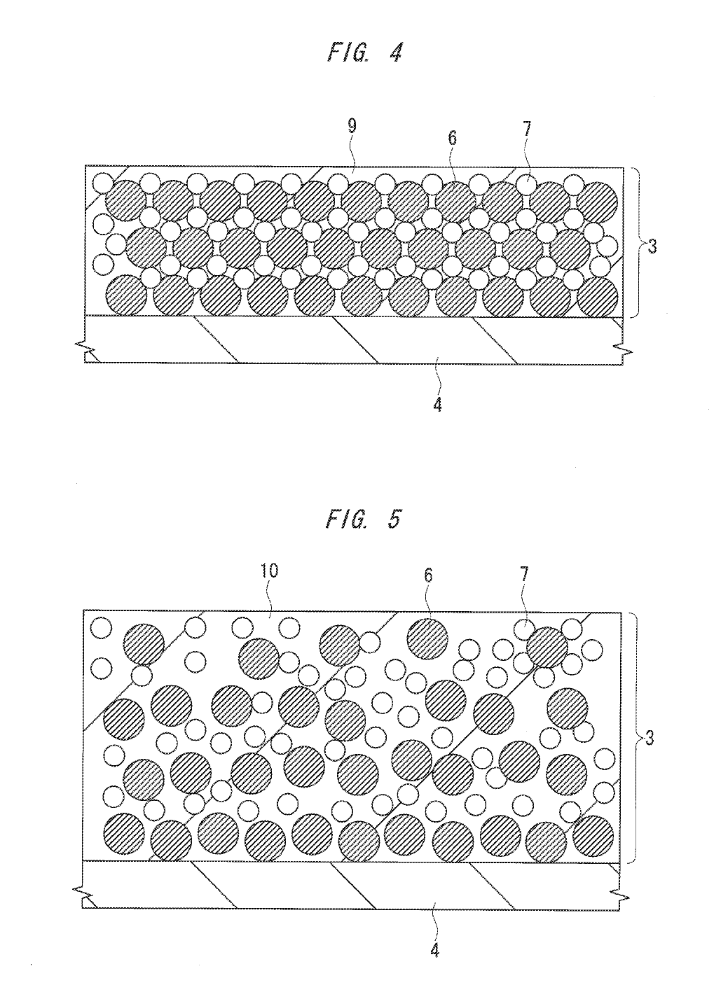

FIG. 4 is a cross sectional view of a main part of a phosphor layer in Example 3. A structure of the vehicle lamp in Example 3 is the same as that in Example 1, described above and illustrated in FIG. 1. Therefore, description thereof will be omitted.

The phosphor layer 3 in Example 3 includes a plurality of phosphor particles 6, a plurality of diffusion reflection particles 7, and a void filling material 9. The phosphor particles 6 are made of a fluorescent material which emits fluorescent light by excitation of blue light. Examples thereof include Y₃Al₅O₁₂:Ce, Y₃(Al,Ga)₅O₁₂:Ce, (Y,Gd)₃Al₅O₁₂:Ce, (Y,Lu)₃Al₅O₁₂:Ce, (Ba,Sr)₂SiO₄:Eu, Ca₃Sc₂Si₃O₁₂:Ce, (Ca,Sr)₂Si₅N₈:Eu, (Ca,Sr)AlSiN₃:Eu, Cax(Si,Al)₁₂(O,N)₁₆:Eu, (Si,Al)₆(O,N)₈:Eu, (Ba,Sr,Ca) Si₂O₂N₂:Eu, Ca₈MgSi₄O₁₆C₁₂:Eu, SrAl₂O₄:Eu, Sr₄Al₁₄O₂₅:Eu, (Ca,Sr)S:Eu, ZnS:Cu,Al, CaGa₂S₄:Eu, and SrGa₂S₄:Eu.

The diffusion reflection particles 7 are made of a material which diffuses and reflects excitation light and slightly absorbs the excitation light and fluorescent light emitted from the phosphor particles 6 It is possible to use a material having a refractive index different from the void filling material 9 among materials having translucency with respect to excitation light and fluorescent light, such as Al₂O₃, MgO, SiO₂, TiO₂, BaSO₄, SrTiO₄, Y₂O₃, La₂O₃, Y₃Al₅O₁₂, diamond, or various clear glass.

A part of the excitation light incident on the diffusion reflection particles 7 is reflected due to a refractive index difference between the surface of the diffusion reflection particles 7 and the void filling material 9. By the particulate shape, a reflection surface with respect to an incident direction of the excitation light is random for each particle, and therefore, a reflection direction is also random. Uniform diffusion reflection can be realized. Apart of the excitation light and fluorescent light goes from the surface of the phosphor layer 3 toward the inside thereof. However, the excitation light and fluorescent light are reflected to the surface of the phosphor layer 3 by the diffusion reflection particles 7 inside the phosphor layer 3. Therefore, the excitation light and fluorescent light can be extracted efficiently to reduce energy loss. A ratio of the excitation light diffused and reflected with respect to the fluorescent light can be adjusted by a mixed amount of the diffusion reflection particles 7.

In Example 3, a material having translucency with respect to excitation light and fluorescent light was used as the diffusion reflection particles 7. However, a material having reflectivity with respect to excitation light and fluorescent light, such as Al, Ag, or Pt, can be also used.

The void filling material 9 is formed so as to fill voids between the phosphor particles 6 and the diffusion reflection particles 7 in the phosphor layer 3. The void filling material 9 is formed such that the phosphor particles 6 and the diffusion reflection particles 7 do not come into contact with the air. The void filling material 9 has low moisture permeability and translucency with respect to excitation light and fluorescent light emitted from the phosphor particles 6. Examples thereof include a silicone resin and an epoxy resin.

In some phosphor materials, luminous characteristics are deteriorated due to moisture. Some diffusion reflection materials change in quality due to moisture, and exhibit absorbing performance with respect to excitation light or fluorescent light. By covering the surfaces of the phosphor particles 6 and the diffusion reflection material 7 with the void filling material 9 having low moisture permeability, deterioration of the phosphor material or the change of the diffusion reflection material in quality can be suppressed.

An example of a method for forming the phosphor layer 3 will be described. The phosphor particles 6 and the diffusion reflection particles 7 are mixed at a predetermined ratio, and compacted with a press machine to obtain a pellet. Subsequently, the pellet is heated in a heating furnace to be sintered. The sintered pellet is soaked in the void filling material 9 before hardening. Thereafter, voids in the pellet are filled with the void filling material 9 by vacuum defoaming. The pellet filled with the void filling material 9 is, for example, heated to harden the void filling material 9. Thereafter, the pellet is fixed to the metal plate 4 using an adhesive, a double sided tape, metal solder bonding, or the like.

### Example 4

In Example 4, an example of a vehicle lamp will be described, which can use a phosphor material or a diffusion reflection material changing in quality by a sintering process in the vehicle lamp described in Example 1.

FIG. 5 is a cross sectional view of a main part of a phosphor layer in Example 4. A structure of the vehicle lamp in Example 4 is the same as that in Example 1, described above and illustrated in FIG. 1. Therefore, description thereof will be omitted.

The phosphor layer 3 in Example 4 includes a plurality of phosphor particles 6, a plurality of diffusion reflection particles 7, and a binder 10. The phosphor particles 6 are made of a fluorescent material which emits fluorescent light by excitation of blue light. Examples thereof include Y₃Al₅O₁₂:Ce, Y₃(Al,Ga)₅O₁₂:Ce, (Y,Gd)₃Al₅O₁₂:Ce, (Y,Lu)₃Al₅O₁₂:Ce, (Ba,Sr)₂SiO₄:Eu, Ca₃Sc₂Si₃O₁₂:Ce, (Ca,Sr)₂Si₅N₈:Eu, (Ca,Sr)AlSiN₃:Eu, Cax(Si,Al)₁₂(O,N)₁₆:Eu, (Si,Al)₆(O,N)₈:Eu, (Ba,Sr,Ca) Si₂O₂N₂:Eu, Ca₈MgSi₄O₁₆C₁₂:Eu, SrAl₂O₄:Eu, Sr₄Al₁₄O₂₅:Eu, (Ca,Sr) S:Eu, ZnS:Cu,Al, CaGa₂S₄:Eu, and SrGa₂S₄:Eu.

The diffusion reflection particles 7 are made of a material which diffuses and reflects excitation light and slightly absorbs the excitation light and fluorescent light emitted from the phosphor particles 6. It is possible to use a material having a refractive index different from the binder 10 among materials having translucency with respect to excitation light and fluorescent light, such as Al₂O₃. MgO, SiO₂, TiO₂, BaSO₄, SrTiO₄, Y₂O₃, La₂O₃, Y₃Al₅O₁₂, diamond, or various clear glass.

A part of the excitation light incident on the diffusion reflection particles 7 is reflected due to a refractive index difference between the surface of the diffusion reflection particles 7 and the binder 10. By the particulate shape, a reflection surface with respect to an incident direction of the excitation light is random for each particle, and therefore, a reflection direction is also random. Uniform diffusion reflection can be realized. Apart of the excitation light and fluorescent light goes from the surface of the phosphor layer 3 toward the inside thereof. However, the excitation light and fluorescent light are reflected to the surface of the phosphor layer 3 by the diffusion reflection particles 7 inside the phosphor layer 3. Therefore, the excitation light and fluorescent light can be extracted efficiently to reduce energy loss. A ratio of the excitation light diffused and reflected with respect to the fluorescent light can be adjusted by a mixed amount of the diffusion reflection particles 7.

In Example 4, a material having translucency with respect to excitation light and fluorescent light was used as the diffusion reflection particles 7. However, a material having reflectivity with respect to excitation light and fluorescent light, such as Al, Ag, or Pt, can be also used.

The phosphor particles 6 and the diffusion reflection particles 7 are held on the metal plate 4 by the binder 10. The binder 10 is made of a material which has translucency with respect to excitation light and fluorescent light and can hold the phosphor particles 6 and the diffusion reflection particles 7 on the metal plate 4 by a relatively low temperature process. Examples thereof include a silicone resin, an epoxy resin, and low melting point glass.

An example of a method for forming the phosphor layer 3 will be described. Here, an example of using a thermosetting silicone resin as the binder 10 will be described. The phosphor particles 6, the diffusion reflection particles 7, and the binder 10 are mixed at a predetermined ratio to obtain a paste. The metal plate 4 is coated with the paste, and then the binder 10 is hardened by heating.

In some phosphor materials, luminous characteristics are deteriorated due to a heating process at a certain temperature or higher. Some diffusion reflection materials change in quality due to heating at a certain temperature or higher, and exhibit absorbing performance with respect to excitation light or fluorescent light. Therefore, when the pellet obtained by mixing the phosphor particles 6 and the diffusion reflection particles 7 is sintered as in Example 1, the phosphor material or the diffusion reflection material may change in quality according to the temperature during sintering. Therefore, the change of the phosphor material or the diffusion reflection material in quality is suppressed by holding the phosphor particles 6 and the diffusion reflection particles 7 by a relatively low temperature process using the binder 10.

### Example 5

In Example 5, an example of a vehicle lamp will be described, which can further reduce regular reflection of excitation light on the surface of the phosphor layer in the vehicle lamp described in Example 3.

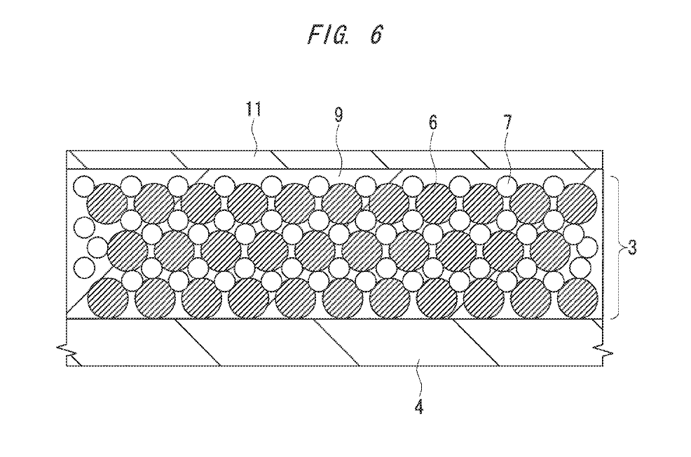

FIG. 6 is a cross sectional view of a main part of a phosphor layer in Example 5. A structure of the vehicle lamp in Example 5 is the same as that in Example 1, described above and illustrated in FIG. 1. Therefore, description thereof will be omitted. A structure of the phosphor layer is the same as that in Example 3, described above and illustrated in FIG. 4. Therefore, description thereof will be omitted.

In Example 5, a reflection preventing film 11 is formed on the surface of the phosphor layer 3. The reflection preventing film 11 suppresses surface reflection of excitation light incident on the phosphor layer 3. Examples thereof include a reflection preventing film using a transparent oxide, an AR (Anti Reflection) film, or the like. The reflection preventing film 11 is formed on the surface of the phosphor layer 3 by deposition, coating, film sticking, or the like.

As in Example 3, when the pellet formed from the phosphor particles 6 and the diffusion reflection particles 7 is covered with the void filling material 9, the surface of the pellet may be even, and regular reflection of excitation light may be increased at the boundary between the void filling material 9 and the air. Regular reflection of excitation light is suppressed by providing the reflection preventing film 11 on the surface of the phosphor layer 3.

Here, the reflection preventing film 11 was formed on the surface of the phosphor layer 3 described in Example 3. However, a complexity prevention film 11 can be formed also on the surface of the phosphor 3 described in Examples 1, 2, and 4.

Hereinabove, the invention achieved by the present inventors have been described specifically based on the embodiments. However, needless to say, the present invention is not limited to the above embodiments, and various change can be performed in a range not departing from a gist thereof.

### REFERENCE SIGNS LIST

1 semiconductor light emitting element
2 condensing lens
3 phosphor layer
4 metal plate
5 reflector
5a reflection surface
6 phosphor particles
7 diffusion reflection particles
8 surface heat conductive material
9 void filling material
10 binder
11 reflection preventing film

1. A light source device comprising:
a light source which emits excitation light; and
a phosphor layer which emits fluorescent light by the excitation light, wherein
the light source device mixes the fluorescent light emitted from the phosphor layer with the excitation light diffused and reflected in the phosphor layer, and emits illumination light,
the phosphor layer includes:
a plurality of phosphor particles which emit the fluorescent light by the excitation light; and
a plurality of diffusion reflection particles which diffuse and reflect the excitation light, and
the plurality of phosphor particles and the plurality of diffusion reflection particles are dispersed in the phosphor layer.

2. The light source device according to claim 1, wherein
the phosphor layer is formed by mixing and sintering the plurality of phosphor particles and the plurality of diffusion reflection particles.

3. The light source device according to claim 2, wherein
the plurality of diffusion reflection particles are made of a material having translucency with respect to the excitation light and the fluorescent light.

4. The light source device according to claim 2, wherein
the plurality of diffusion reflection particles are made of a material having reflectivity with respect to the excitation light and the fluorescent light.

5. The light source device according to claim 2, wherein
a surface of the phosphor layer is covered with a material having translucency with respect to the excitation light and the fluorescent light and having thermal conductivity, and
the plurality of phosphor particles are not exposed to the surface of the fluorescent layer.

6. The light source device according to claim 1, wherein
the phosphor layer is formed by mixing and sintering the plurality of phosphor particles and the plurality of diffusion reflection particles, and
voids between the plurality of phosphor particles and the plurality of diffusion reflection particles are filled with a filling material having translucency with respect to the excitation light and the fluorescent light.

7. The light source device according to claim 6, wherein
the plurality of diffusion reflection particles are made of a material having translucency with respect to the excitation light and the fluorescent light, and having a higher refractive index than the filling material.

8. The light source device according to claim 6, wherein
the plurality of diffusion reflection particles are made of a material having reflectivity with respect to the excitation light and the fluorescent light.

9. The light source device according to claim 1, wherein
the plurality of phosphor particles and the plurality of diffusion reflection particles are dispersed in a filling material having translucency with respect to the excitation light and the fluorescent light.

10. The light source device according to claim 9, wherein
the plurality of diffusion reflection particles are made of a material having translucency with respect to the excitation light and the fluorescent light, and having a higher refractive index than the filling material.

11. The light source device according to claim 9, wherein
the plurality of diffusion reflection particles are made of a material having reflectivity with respect to the excitation light and the fluorescent light.

12. The light source device according to claim 1, wherein
a reflection preventing film with respect to the excitation light is formed on the surface of the phosphor layer.

13. A vehicle lamp using a light source device, wherein
the light source device includes:
a light source which emits excitation light; and
a phosphor layer which emits fluorescent light by the excitation light, wherein
the light source device emits illumination light in which the fluorescent light emitted from the phosphor layer and the excitation light diffused and reflected in the phosphor layer are mixed,
the phosphor layer includes:
a plurality of phosphor particles which emit the fluorescent light by the excitation light; and
a plurality of diffusion reflection particles which diffuse and reflect the excitation light, and
the plurality of phosphor particles and the plurality of diffusion reflection particles are dispersed in the phosphor layer.
